(19) United States
(12) Patent Application Publication
(10) Pub. No.: US 2003/0079535 A1
(43) Pub. Date: May 1, 2003

(54) Pressure indicating device for tire

(76) Inventor: Mu-Chuan Hsu, Taipei (TW)

Correspondence Address: Alan D. Kamrath, Rider, Bennett, Egan & Arundel, LLP, 333 South Seventh Street, Suite 2000, Minneapolis, MN, 55402, US

(21) Appl. No.: 10/046,476

(22) Filed: Oct. 29, 2001

(51) Int. Cl. G01M 17/02

(52) U.S. Cl. 73/146

(57) ABSTRACT

An apparatus mounted on a valve of each of a plurality of tires of motor vehicle for indicating a pressure thereof. The apparatus comprises a first portion projected from the tire, a second portion inserted into the tire and in communication with air therein, and a scale on the first portion for facilitating a display of tire pressure.

### FIELD OF THE INVENTION

The present invention relates to tires of motor vehicle and more particularly to a pressure indicating device for tire of motor vehicle with improved characteristics

### BACKGROUND OF THE INVENTION

As understood that good tires are important to a safe driving. However, most drivers do not take much attention to tires before driving. Thus, it is common for the occurring of tire(s) broken while driving. In a worst case, it may cause a traffic accident. Thus, it is desirable to provide a pressure indicating device for tire so that driver can be aware of the pressure of each tire before driving.

### SUMMARY OF THE INVENTION

It is therefore an object of the present invention to provide an apparatus mounted on a valve of each of a plurality of tires of motor vehicle for indicating a pressure thereof. The apparatus comprises a first portion projected from the tire, a second portion inserted into the tire and in communication with air therein and a scale on the first portion.

The above and other objects, features and advantages of the present invention will become apparent from the following detailed description taken with the accompanying drawings.

### BRIEF DESCRIPTION OF THE DRAWINGS

FIG. 1 is a side view showing a wheel with fixed tire incorporating a pressure indicating device according to a first preferred embodiment of the invention,

FIG. 2 is a cross-sectional view of the scale member with bellow member of FIG. 1 pressure indicating device being expanded by inflated air;

FIG. 3 is a cross-sectional view of assembled pressure indicating device according to a second preferred embodiment of the invention and valve illustrating an air flow for indicating pressure of tire,

FIG. 4 is a cross-sectional view of assembled pressure indicating device according to a third preferred embodiment of the invention and valve;

FIG. 5 is a cross-sectional view of assembled pressure indicating device according to a fourth preferred embodiment of the invention and valve with a greatly enlarged fragmentary view on top showing the area in circle A, and

FIG. 6 is a cross-sectional view of pressure indicating device according to a fifth preferred embodiment of the invention, where pressure indicating device is mounted on valve

### DETAILED DESCRIPTION OF THE PREFERRED EMBODIMENTS

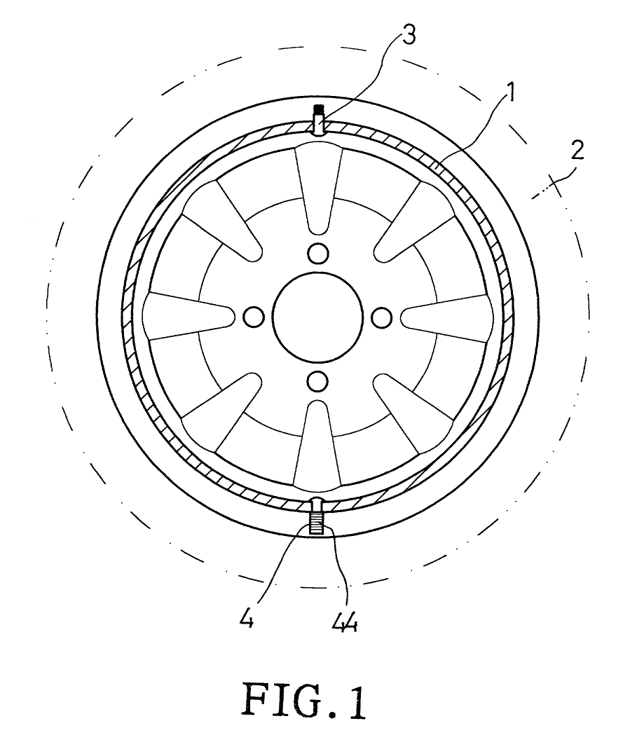

Referring to FIG. 1, there is shown a wheel having a tire 2 fixed about rim 1, a valve 3 through rim 1 for pumping air into tire 2, a pressure indicating device 4 of a first preferred embodiment within tire 2 being in communication with air therein, and a scale member 44 through and projected from rim 1, scale member 44 being coupled to one end of pressure indicating device 4 in which both pressure indicating device 4 and scale member 44 are constructed in accordance with the invention

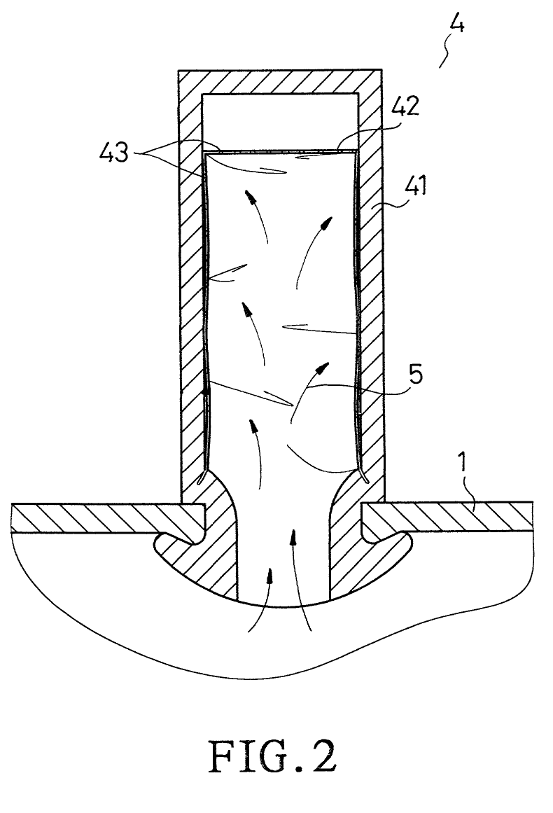

Referring to FIG. 2 in conjunction with FIG. 1, scale member 44 is a hollow cylinder with top (i.e., outer end) enclosed. Scale member 44 is formed of hard, transparent plastic material. Scale member 44 has a scale 41 Within scale member 44, there is provided a bellow member 42. Bellow member 42 is formed of strong elastic material having its wavy peripheral section 43 urged against the inner periphery of scale member 44 by the pressure of air 5 of tire 2 Also, top of bellow member 42 may lift or lower due to the nature of elastic material as the pressure of air 5 of tire 2 changes. In use, prior to driving driver can know the pressure of tire 2 by observing the top of bellow member 42 which is aligned with a certain scale 41

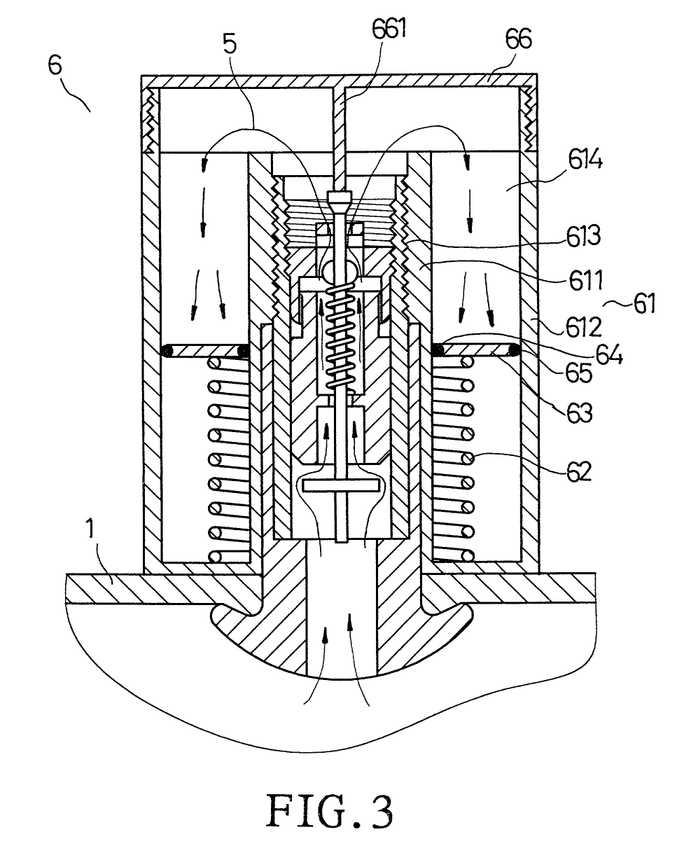

Referring to FIG. 3, a pressure indicating device 6 of a second preferred embodiment mounted on a valve is shown. Pressure indicating device 6 comprises a base 61 consisting of an inner hollow cylinder 611 having an inner threaded section being secured to outer threaded section of valve and an outer hollow cylinder 612 with bottoms of cylinders 611 and 612 coupled together as a closed section and tops thereof open, thus forming a space 614 between cylinders 611 and 612, a helical spring 62 put on inner hollow cylinder 611 having a lower end rested on bottom of base 61, a hollow disk-shaped seal 63 put on inner hollow cylinder 611 being urged by top of the biased spring 62, an outer ring 65 sleeved between seal 63 and inner wall of outer hollow cylinder 612; an inner ring 64 sleeved between seal 63 and outer wall of inner hollow cylinder 611 so as to eliminate a potential air flow through inner or outer periphery of seal 63, and a cap 66 having a downward peg 661 engaged with air inlet of valve, cap 66 being threadedly secured to top of base 61 If driver wants to know the pressure of tire the driver can mount pressure indicating device 6 on valve. At this position, air is flowed from tire to push down seal 63 through valve and pressure indicating device 6 as indicated by arrow 5 in FIG. 3. Thus, driver can know the pressure of tire by observing the seal 63 which is aligned with one of marks of the scale.

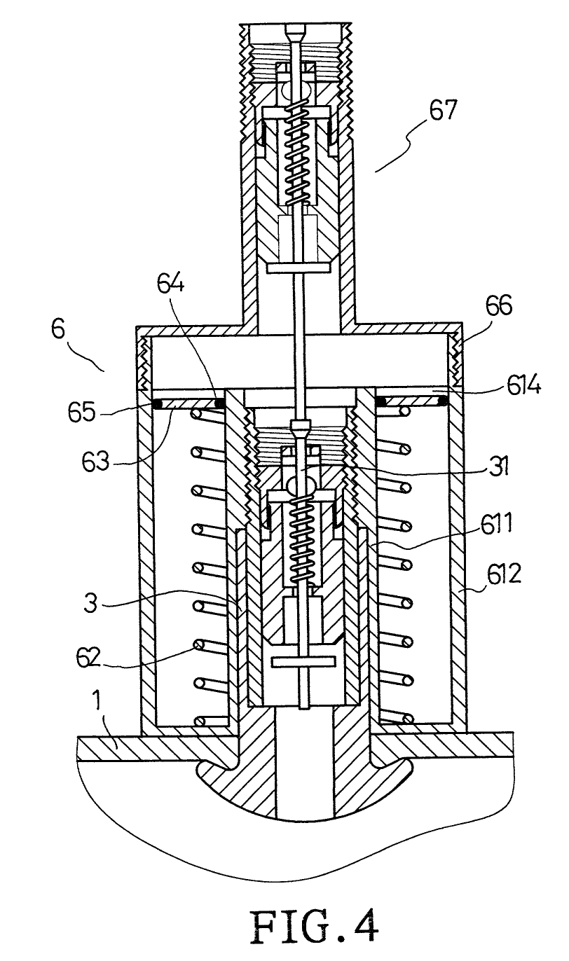

Referring to FIG. 4, there is shown a third preferred embodiment of pressure indicating device 6 constructed in accordance with the invention. The difference between second and third preferred embodiments is detailed below A well known second valve 67 is formed on top of and in communication with pressure indicating device 6 This has the benefit of no need to disengage pressure indicating device 6 from valve for inflating tire.

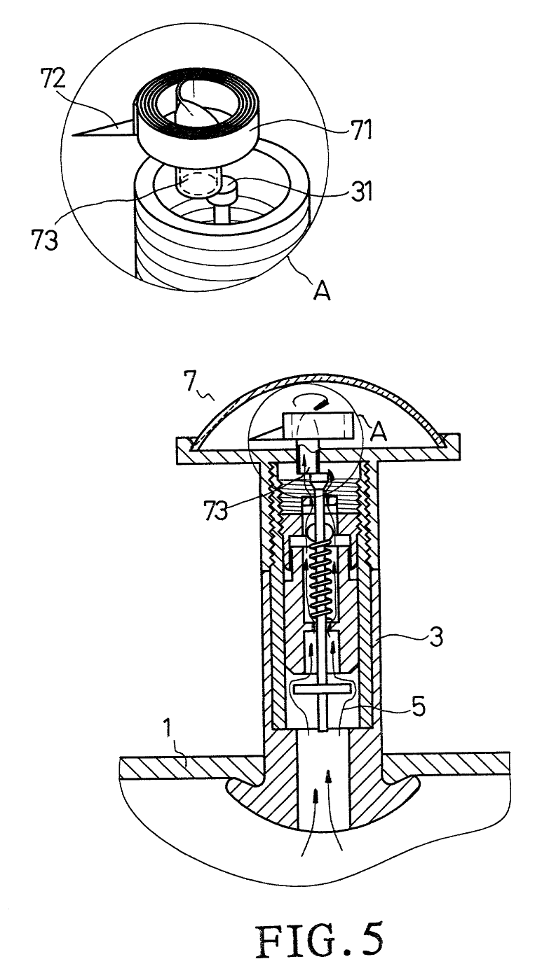

Referring to FIG. 5, there is shown a fourth preferred embodiment of pressure indicating device 7 constructed in accordance with the invention mountable on a valve 3 which is projected from rim 1 of tire of an automobile The pressure indicating device 7 is threadedly secured onto top of valve 3 The pressure indicating device 7 comprises a hollow cylinder 73 projected from bottom, a mainspring 71 having one end coupled to the cylinder 73, the mainspring 71 being capable of pivoting as air through cylinder 73, and a pointer 72 coupled to the other end of mainspring 71 In a mounted state of pressure indicating device 7 and valve 3, cylinder 73 is urged against elongate slender bar 31 of valve 3 to press down the elongate slender bar 31 a predetermined distance. Hence, air is flowed from tire to mainspring 71 through valve 3, and cylinder 73. As a result, pointer 72 is pivoted an angle proportioned to the pressure of air applied on mainspring 71 In brief, it is possible of knowing a pressure of tire by mounting pressure indicating device 7 on valve 3

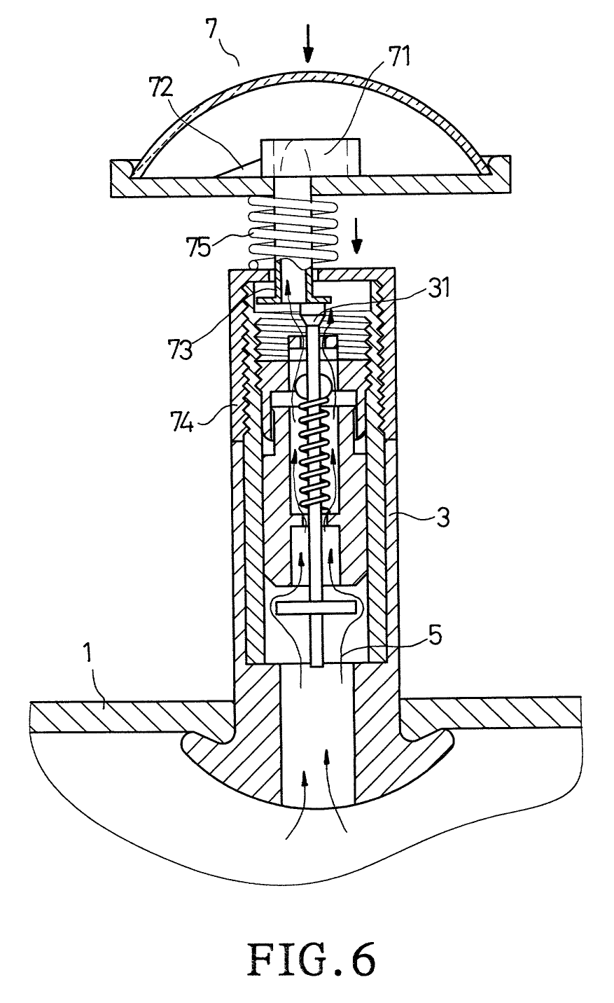

Referring to FIG. 6, there is shown a fifth preferred embodiment of pressure indicating device 7 constructed in accordance with the invention The differences between fourth and fifth preferred embodiments are detailed below The pressure indicating device 7 of fifth preferred embodiment further comprises a spring 75 put on cylinder 73 and a cap 74 having an inner thread so as to threadedly secure to outer threaded section of valve 3. In a case that for example, driver wants to know the pressure of tire the driver can press pressure indicating device 7 to compress spring 75 so as to urge top of elongate slender bar 31 by the cylinder 73. Hence, elongate slender bar 31 is pressed down a predetermined distance. Accordingly, air is flowed from tire to mainspring 71 through valve 3 and cylinder 73. Pointer 64 is thus pivoted an angle proportioned to the pressure of air applied on mainspring 71 In brief, it is possible of knowing a pressure of tire by pressing pressure indicating device 7 on valve 3.

While the invention has been described by means of specific embodiments, numerous modifications and variations could be made thereto by those skilled in the art without departing from the scope and spirit of the invention set forth in the claims.

What is claimed is:

1. An apparatus mounted on a valve of each of a plurality of tires of motor vehicle for indicating a pressure thereof, the apparatus comprising a first portion projected from the tire, a second portion inserted into the tire and in communication with air therein, and a scale on the first portion
